(19) United States
(12) Patent Application Publication
(10) Pub. No.: US 2015/0183172 A1
(43) Pub. Date: Jul. 2, 2015

(54) METHOD FOR REPAIRING ELECTRONIC DEVICE

(71) Applicant: HON HAI PRECISION INDUSTRY CO., LTD., New Taipei (TW)

(72) Inventors: MING-JEN CHANG, New Taipei (TW); JHIH-KUEI GE, New Taipei (TW); YU-TING CHIU, New Taipei (TW)

(21) Appl. No.: 14/583,101

(22) Filed: Dec. 25, 2014

(30) Foreign Application Priority Data
Dec. 26, 2013 (TW) 102148558

(51) Int. Cl. B29C 73/00; B32B 43/00

(52) U.S. Cl. CPC B29C 73/00; B32B 43/006

(57) ABSTRACT

A method is employed for repairing an electronic device. The electronic device includes a base plate, a component installed on the base plate, and a second workpiece adhered on the base plate by an adhesive agent which is positioned adjacent to or away from the component. The method includes the following procedures. A reflective layer is formed on a side of the base plate away from the component to cover the part of the base plate corresponding to the component, and the reflective protection layer is capable of reflecting infrared radiation to protect the component. The adhesive agent is softened by infrared radiation to decrease an adhesive strength of the adhesive agent. The remaining reflective protection layer is removed. The electronic device is dissembled to separate the first workpiece from the second workpiece.

### FIELD

The subject matter herein generally relates to a method for repairing an electronic device.

### BACKGROUND

When an electronic device is malfunctioning or broken, the electronic device should be disassembled for repair.

### BRIEF DESCRIPTION OF THE DRAWINGS

Implementations of the present technology will now be described, by way of example only, with reference to the attached figures.

FIG. 1 is a flowchart of an embodiment of a method for repairing an electronic device.

FIG. 2 is a cross-sectional view of the electronic device of FIG. 1, including a first workpiece and a second workpiece assembled to the first workpiece by an adhesive agent.

FIG. 3 a cross-sectional view of the electronic device of FIG. 2 after a process of forming a reflective protection layer.

FIG. 4 is a cross-sectional view of the electronic device of FIG. 3 after a process of removing a part of the reflective protection layer.

FIG. 5 is a cross-sectional view of the electronic device of FIG. 4 after a process of softening the adhesive agent.

FIG. 6 is a cross-sectional view of the electronic device of FIG. 5 after a process of removing the remaining reflective protection layer.

FIG. 7 is a cross-sectional view of the electronic device of FIG. 6 after a process of separating the second workpiece from the first workpiece.

### DETAILED DESCRIPTION

It will be appreciated that for simplicity and clarity of illustration, where appropriate, reference numerals have been repeated among the different figures to indicate corresponding or analogous workpieces. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that apply throughout this disclosure will now be presented.

The term “comprising,” when utilized, means “including, but not necessarily limited to”; it specifically indicates open-ended inclusion or membership in the so-described combination, group, series and the like.

A method can be employed for repairing an electronic device. The electronic device can include a first workpiece with a base plate with a component installed on the base plate, and a second workpiece adhered to the first workpiece by an adhesive agent which is positioned adjacent to or away from the component. The method can include: forming a reflective protection layer on a side of the base plate away from the component to cover the part of the base plate corresponding to the component, the reflective protection layer being capable of reflecting infrared radiation to protect the component; softening the adhesive agent by infrared radiation to decrease an adhesive strength of the adhesive agent; removing the reflective protection layer; and disassembling the electronic device to separate the first workpiece from the second workpiece.

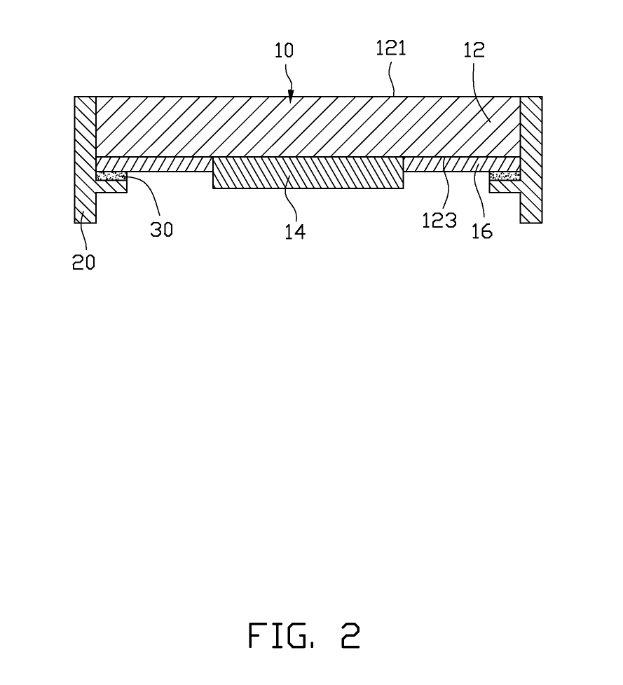

FIG. 2 illustrates an embodiment of an electronic device 100 configured to be disassembled for repair. The electronic device 100 can include a first workpiece 10, a second workpiece 20, and an adhesive agent 30. The first workpiece 10 can be adhered to the second workpiece 20 via the adhesive agent 30. The first workpiece 10 can include a base plate 12, a component 14, and a shielding layer 16. The base plate 12 can be transparent to infrared radiation. The base plate 12 can include a first surface 121, and a second surface 123 opposite to the first surface 121. The component 14 and the shielding layer 16 can both be formed on the second surface 123 of the base plate 12, and can cooperatively cover the whole base plate 12. The shielding layer 16 can surround the component 14. The adhesive agent 30 can be coated onto the shielding layer 16 to adhere the first workpiece 10 to the second workpiece 20, and positioned away from the component 14. When the component 14 is malfunctioning or broken, the second workpiece 20 can be removed to expose the component 14, and then the component 14 can be repaired. In at least one embodiment, the electronic device 100 can be a cell phone, the first workpiece 10 can be a touch panel, the base plate 12 can be a glass plate, the component 14 can be touch electrodes, and the second workpiece 20 can be a housing. The adhesive agent 30 can be made of one or more epoxy resins. The adhesive agent 30 can have a strong adhering strength and be solidified in a temperature range from 0 to 180 degrees Celsius.

In at least one embodiment, the adhesive agent 30 can be made of other materials, such as acrylic resins, polyurethane, silicone, so long as the first workpiece 10 and the second workpiece 20 can be strongly adhered together by the adhesive agent 30. In at least one embodiment, the adhesive agent 30 can be positioned adjacent to the component 14. In at least one embodiment, the base plate 12 can be made of other materials which are transparent to infrared radiation, such as plastic. In at least one embodiment, the electronic device 100 can be a camera, the first workpiece 10 can be a top housing of the camera, the second workpiece 20 can be a bottom housing of the camera, the top housing and the bottom housing can cooperatively form a housing of the camera, the component 14 can be a camera module received in the housing. In at least one embodiment, the electronic device 100 can be other electronic products, such as televisions.

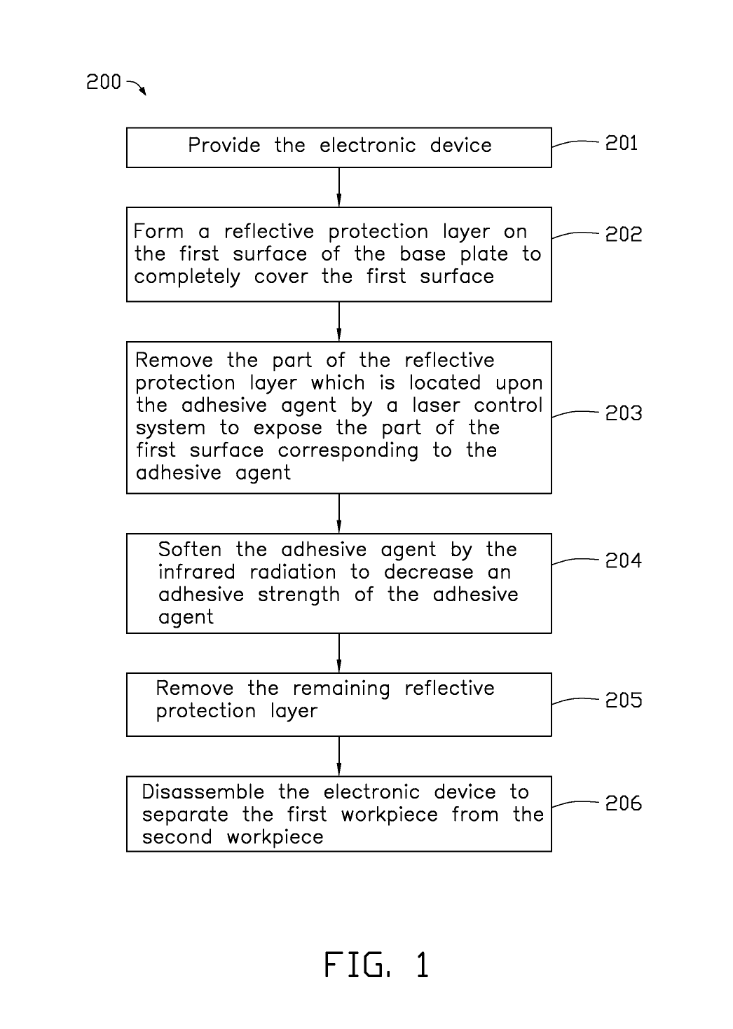

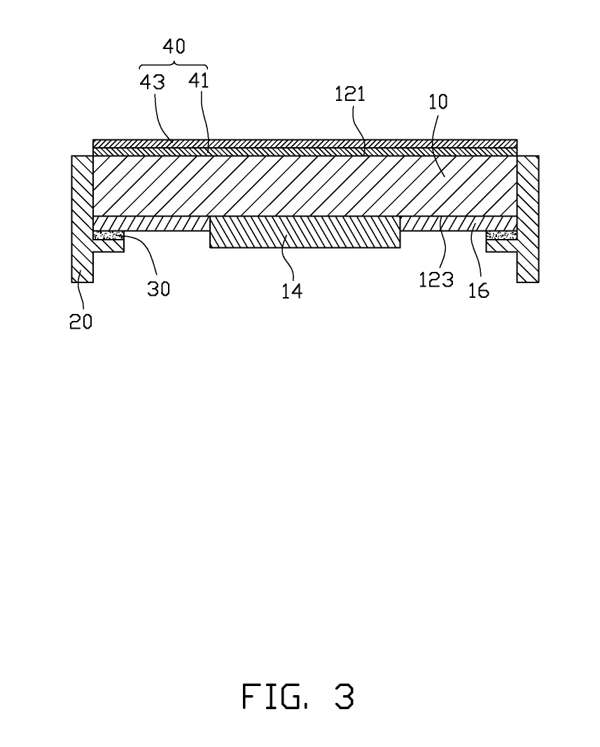

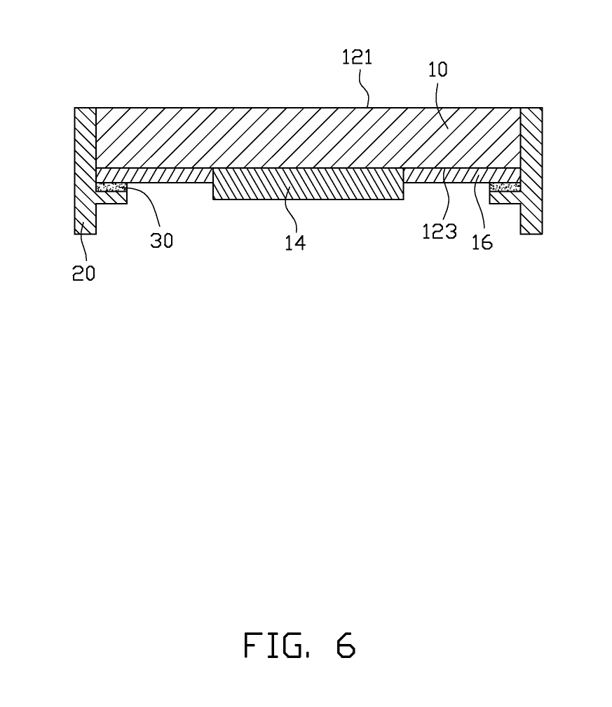

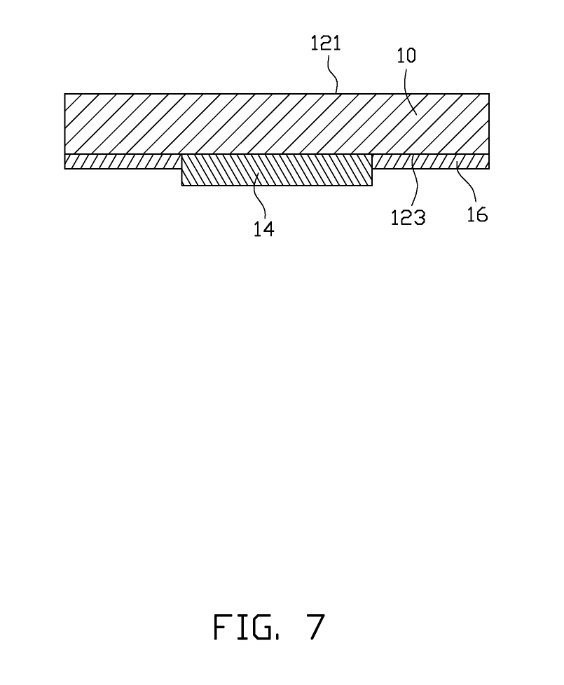

FIGS. 3 to 7 illustrate the process for repairing the electronic device in accordance with an example embodiment. The example method 200 is provided by way of example, as there are a variety of ways to carry out the method. The method 200 described below can be carried out using the configurations illustrated in FIGS. 3 to 7, for example, and various workpieces of these figures are referenced in explaining example method 200. Each block shown in FIG. 1 represents one or more processes, methods or subroutines, carried out in the example method 200. Furthermore, the illustrated order of blocks is by example only and the order of the blocks can change according to the present disclosure. Additional blocks may be added or fewer blocks may be utilized, without departing from this disclosure. The example method 200 for repairing the electronic device 100 can begin at block 201.

At block 201, the electronic device is provided.

At block 202, a reflective protection layer is formed on the first surface of the base plate and completely covers the first surface.

FIG. 3 illustrates that the reflective protection layer 40 can have a poor heat conducting property, and an excellent heat resistance property and reflection property. The reflective protection layer 40 can reflect the infrared radiation to protect the base plate and the component 14 from being heated by the infrared radiation. The reflective protection layer 40 can include a silicone pad 41 and an aluminum foil sticker 43 stacked on the silicone pad 41. The silicone pad 41 can be formed on the first surface 121, and can completely cover the first surface 121. The aluminum foil sticker 43 can reflect the infrared radiation emitted to the aluminum foil sticker 43. In at least one embodiment, the reflective protection layer 40 can cover a portion of the first surface 121, such as the portion corresponding to the component 14, and part of the shielding layer 16, so long as the reflective protection layer 40 can protect the component 14 from being exposed to infrared radiation.

At block 203, the part of the reflective protection layer which is located upon the adhesive agent is removed by a laser control system to expose the part of the first surface corresponding to the adhesive agent.

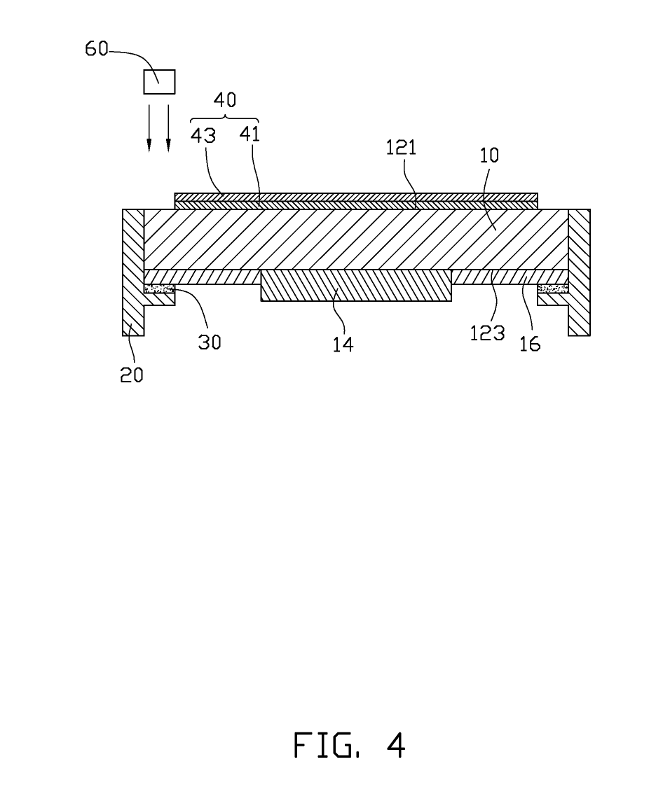

FIG. 4 illustrates that when removing the reflective protection layer 40, the laser control system 60 can read a predetermined path, and can remove the part of the reflective protection layer 40 which corresponds to the adhesive agent according to the predetermined path. The predetermined path can be a dispensing path coating on the shielding layer 16 used in assembling of the electronic device by automatic dispensing equipment (not shown). The laser control system 60 can emit a number of laser beams which have high power. When a power density of the laser beams is more than a threshold power density of the reflective protection layer 40, the protection layer 40 can be vaporized by the laser beams. In this way, the part of the first surface 121 corresponding to the adhesive agent 30 can be exposed. In at least one embodiment, when the reflective protection layer 40 cannot cover the part of the first surface 121 corresponding to the adhesive agent 30, the step of removing the reflective protection layer can be omitted.

At block 204, the adhesive agent is softened by the infrared radiation to decrease an adhesive strength of the adhesive agent.

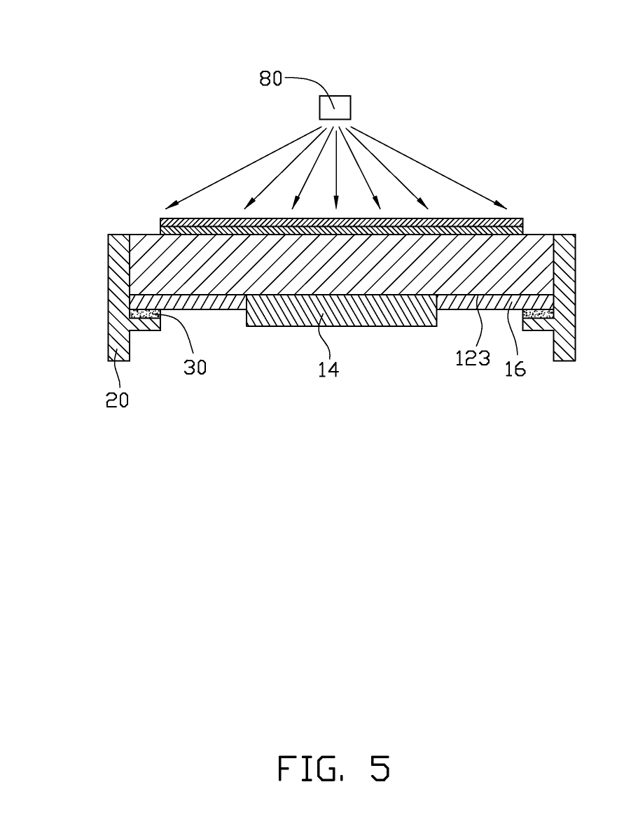

FIG. 5 illustrates that an infrared emission device 80 can emit infrared radiation to the shielding layer 16 via the base plate, the heat energy of the infrared radiation can be transmitted to the adhesive agent 30 via the shielding layer 16, and then the adhesive agent 30 can be heated, thus the adhesive agent 30 is softened. The wavelengths of the infrared radiation can be in a range from 760 nanometers to 1 millimeter. A heating time of the adhesive agent 30 can be in a range from 5 seconds to 5 minutes. Because the component 14 is shielded by the reflective protection layer 40, the infrared radiation cannot damage the component 14.

At block 205, the remaining reflective protection layer is removed. In at least one embodiment, the remaining reflective protection layer 40 can be removed by methods well known in the art, such as a method of tearing, a method of dissolving, and a method employing high pressure cleaning equipment.

At block 206, the electronic device is disassembled to separate the first workpiece from the second workpiece.

In at least one embodiment, after the step of disassembling the electronic device, the adhesive agent 30 can be scraped off

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A method for repairing an electronic device, comprising a first workpiece with a base plate with a component installed on the base plate and a second workpiece adhered to the first workpiece by an adhesive agent which is positioned adjacent to or away from the component, the method comprising:
forming a reflective protection layer on a side of the base plate away from the component to cover the part of the base plate corresponding to the component, the reflective protection layer being capable of reflecting infrared radiation to protect the component;
softening the adhesive agent by infrared radiation to decrease an adhesive strength of the adhesive agent;
removing the reflective protection layer; and
disassembling the electronic device to separate the first workpiece from the second workpiece.

2. The method of claim 1, wherein the reflective protection layer comprises a silicone pad positioned on and covering the base plate, and an aluminum foil sticker stacked on the silicone pad.

3. The method of claim 1, wherein the adhesive agent is heated for a predetermined time in the step of softening the adhesive agent.

4. The method of claim 3, wherein the predetermined time is in a range from 5 seconds to 5 minutes.

5. The method of claim 1, wherein the reflective protection layer is removed by one or more methods selected from the group consisting of a method of tearing, a method of dissolving, a method employing high pressure cleaning equipment.

6. The method of claim 1, wherein the reflective protection layer further covers a part of the base plate corresponding to the adhesive agent, the method further comprises a step before the step of softening the adhesive agent: removing the part of the reflective protection layer located upon the adhesive agent to expose the part of the base plate corresponding to the adhesive agent.

7. The method of claim 6, wherein the part of the reflective protection layer located upon the adhesive agent is removed by a laser control system.

8. The method of claim 7, wherein in the step of removing the part of the reflective protection layer located upon the adhesive agent, the laser control system reads a predetermined path which is a dispensing path used in assembling of the electronic device, and removes the part of the reflective protection layer according to the predetermined path.

9. The method of claim 1, wherein the wave lengths of the infrared radiation are in a range from 760 nanometers to 1 millimeter.

10. The method of claim 1, further comprising a step after the step of disassembling the electronic device: scrapping off the adhesive agent.

11. The method of claim 1, wherein the electronic device further comprises a shielding layer positioned on the base plate and surrounding the component.
